(19) United States
(12) Patent Application Publication
(10) Pub. No.: US 2009/0234514 A1
(43) Pub. Date: Sep. 17, 2009

(54) Method and Device for Executing Prioritized Control Processes

(75) Inventors: Juergen Becker, Woerth (DE); Joachim Eisenmann, Süßen (DE); Sibylle Cornelia Eisenmann, Süßen (DE); Markus Fabian Eisenmann, Süßen (DE); Tobias Eisenmann, Süßen (DE); Michael Huebner, Karlsruhe (DE); Juergen Luka, Tamm (DE)

Correspondence Address: CROWELL & MORING LLP;INTELLECTUAL PROPERTY GROUP, P.O. BOX 14300, WASHINGTON, DC, 20044-4300, US

(73) Assignee: DiamlerChrysler AG, Stuttgart (DE)

(21) Appl. No.: 11/885,499

(22) PCT Filed: Feb. 22, 2006
(86) PCT No.: PCT/EP2006/001579

§ 371 Date: Jan. 14, 2009

(30) Foreign Application Priority Data
Mar. 4, 2005 (DE) 10 2005 010 477.0

(51) Int. Cl. G06F 9/46; G06F 7/00

(52) U.S. Cl. 701/1; 718/103

(57) ABSTRACT

A system for controlling a plurality of components in a means of transportation includes a control device with a first control program for a first component and additional control programs for additional components. Each control program carries out a chronologically limited process to control the assigned component. Processes are executed for the components which can be actuated in parallel on the same control device. To each of the processes is assigned a priority identifier that is compared with that of other processes to determine if the process is input into a waiting memory, and to determine the process with the highest priority to start controlling the corresponding component. The priority identifier is allocated dynamically depending on different conditions of the means of transportation.

### CROSS REFERENCE TO RELATED APPLICATIONS

This application is a national stage of PCT International Application No. PCT/EP2006/001579, filed Feb. 22, 2006, which claims priority under 35 U.S.C. § 119 to German Patent Application No. 10 2005 010 477.0 filed Mar. 4, 2005, the entire disclosures of which are herein expressly incorporated by reference.

### BACKGROUND AND SUMMARY OF THE INVENTION

The invention relates to a method for controlling a plurality of components in a means of transportation, i.e. a vehicle, which is provided with a control device with a first control program for a first component and with a second control program for a second component, with each control program carrying out a chronologically limited process in order to control the assigned component, in which each process is determined by a start point and an end point. The device is a piece of equipment for controlling components in a vehicle with an interface to an external data bus, a hardware module and a memory for making available the data.

Nowadays, control devices which actuate different components such as, for example, window lifters, a sunroof and engine components are used in a vehicle. The control devices are networked to one another in order to communicate by using an electric data bus. Electronic networking in a vehicle is becoming increasingly complex with up to 70 networked control devices.

The processes which are executed by the control devices are chronologically limited control tasks so that a control device for window lifters and a sunroof carries out control tasks in only a relatively short time period compared to the overall running time of the vehicle. In the time frames in which the assigned components are not actuated, the data processing resource of the control device remains unused. On the other hand, the compression of the control tasks on a single passenger compartment control device leads to running time problems, and important control tasks possibly have to wait until preceding control tasks are executed by the serial data processing processor. In the past this has frequently lead to an additional control device being installed in the vehicle for other functionalities. As a result, a plurality of functions are rarely required simultaneously in the passenger compartment so that a large number of control devices mainly wait in a passive way to be requested by the vehicle occupants.

International patent publication WO 2004/084066 A discloses a control device having a processor, in which, when there is high capacity utilization of the processor, priorities are allocated to the control processes and depending on the priority these control processes are assigned a specific executing time. However, with control processes which are critical for safety, there is the problem that the processes with lower priority have to be subdivided because of short processing time periods, and are therefore processed repeatedly in the processor. As a result, these components are actuated with a time delay.

International patent publication DE 44 10 775 A1 describes a control device for controlling functions in a motor vehicle in which the execution of processes is coordinated chronologically by a priority-based stack processing method. A differentiation is made between the states of “ready” and “running” for each process. Ready processes are stored in a waiting memory ordered according to their priority. When the running process is concluded, that process which has the highest priority is selected from the waiting memory and started. The processes are executed sequentially on a conventional control device architecture. A similar method is also presented by German patent document DE 197 44 230 A1.

A further approach leads to the communications tasks and control tasks being separated within a control device so that a separate processor, in addition to the communications processor, is provided for actuating the components, and as a result it is possible to provide a higher density of control processes for different components on the same control device. German patent document DE 101 604 76 discloses such a control device with two processors in the context of actuating the engine or the transmission, which is costly in terms of computing time.

In addition, control devices are known which have a conventional microcomputer and whose interfaces are implemented by using a field programmable gate array (FPGA). Such hardware is known from German patent document DE 101 396 10 or DE 101 59 480 A1. The interface hardware can be reconfigured by using a FPGA. In contrast to the customary loading of modified software, in this context use is made of the property of wiring the individual memory cells of the FPGA to one another in different ways. In the FPGA, each memory cell is connected to a networking matrix which can be modified by reconfiguration. For example, by using a FPGA it is possible to simulate logic modules, the modules being described in a hardware description language. By downloading the hardware configuration generated from the hardware description onto the networking controller it is possible to set the wiring between the memory cells in such a way that the desired logic gates are produced.

Customary conventional hardware cannot be modified during the running time. In contrast to this, using an FPGA this networking can be set by downloading a further hardware configuration onto the FPGA, in such a way that another logic module is produced. In this context, the memory cells of the FPGA are wired as in flip-flops and it is possible to construct all the logic units and data processing hardware structures from these flip-flops.

By reconfiguring the FPGA it is possible, for example, to produce a data processing unit which has the structure of a microcomputer, from a first logic gate. It is then possible again to load the conventional software for execution onto this FPGA data processing unit. Such reconfigurable memory units with a data processing functionality, such as logic gates and simulated computing units, are referred to in the following description as a hardware module. The hardware modules are not considered also to include the non-reconfigurable data processing units and hardware circuits.

A future requirement for the system architecture in a vehicle is to reduce the number of control devices and at the same time increase the capacity utilization of the data processing units.

The present invention provides a method with which control processes in a vehicle can be carried out with a high data processing density on hardware modules, without important processes being executed too late. In addition, an expanded control device is proposed with which such a method can be carried out.

This and other objects and advantages are achieved by the method and apparatus according to the invention, for controlling the execution of processes in a control device for a vehicle having a plurality of hardware modules, in which each of the processes is assigned a priority identifier. At the start of the first process it is checked whether another running process has already been executed, and if so, the first process is input into a waiting memory. The next process to be executed is then read out of the waiting memory in accordance with its priority identifier, and after the running process has been concluded, either by regular conclusion or an abort, this new process with the highest priority is provided with the control of the assigned component for data processing.

According to the invention, the priority identifier is allocated dynamically. When there are different traveling situations or operator control situations of the vehicle, priority is allocated to the different processes in a different way. This prioritization method for control processes makes it possible to select, from a plurality of control processes stored in a waiting memory, the control process which is most important or whose timing is most critical for the situation, and to assign it to a hardware module for execution. The prioritization method is particularly suitable for distributing control processes to be executed among a plurality of hardware modules for data processing. In one embodiment, a distribution unit which is assigned to the waiting memory assigns the sequenced control processes in accordance with their prioritization to the different hardware modules for data processing.

The hardware modules of the embodiment are either conventional data processing units, such as logic circuits or microprocessors, or reconfigurable memory units, such as, for example, a FPGA. According to this method, the system selects the process with the highest priority from the waiting memory, and assigns it to one of the hardware modules which are available in parallel so that the quickest possible, reliable execution can be carried out.

In particular, if the hardware modules include reconfigurable hardware, it is possible to generate electronic modules which can be adapted flexibly. It is even possible in this embodiment to provide for a plurality of computing units to be produced within one hardware module by configuring one FPGA. For this purpose, a hardware configuration is loaded onto the FPGA each time, in order to reconfigure it. The control process is then carried out on the exemplary FPGA, and after its execution, the FPGA is then configured for the next process which is assigned to it. The partially dynamic reconfiguration of such hardware modules is controlled using a preprogrammed hardware configuration stored in a small library for the different configurations. Depending on when a process is requested, the corresponding hardware configuration is loaded into the FPGA, the latter is reconfigured and the control process is executed on it.

The method according to the invention, in conjunction with the expanded functionality of the hardware modules, permits the number of control devices within a control device architecture in the vehicle to be reduced. The multiple use of the different hardware modules for different control processes permits the overall necessary chip area to be decreased. Genuine parallel and decoupled processes are possible on one chip or a single hardware module, chip area parts being reconfigured and processes being executed completely on these chip area parts. Functions which can be tested independently of one another and re-used are produced. For example, if a window lifter is actuated and a FPGA is configured on the hardware module, this topology can, if appropriate, be used to control a further window lifter. Reconfiguring the hardware modules produces a way of making available functions in accordance with requirements, as a result of which there is no need for unnecessary management of resources.

In one advantageous embodiment of the invention, differentiation into at least two states is carried out for the allocation of the dynamic priority identifier. In a first operating state of the vehicle, when the latter is, for example, moving on a road, different priority identifiers are allocated for the same component or the same process compared to when the vehicle is in a state of rest, in which it is parked, or at least not moving in terms of transportation.

This different allocation of priority identifier allows, for example, a high prioritization to be assigned to a sunroof arrangement in a state of rest so that this is executed preferentially, while in the traveling state there may be a waiting time of several seconds until the process is executed when the sunroof is activated, because of its lower priority. The driver will hardly be aware of the relatively short waiting time, while the hardware modules can in the meantime execute high priority processes such as, for example, the transmission and actuation of safety-related signals, for example the triggering of an airbag. As a result, a relatively low priority identifier can be assigned to the process for the sunroof in the operating state of the vehicle, so that the process for activating the sunroof is not carried out until after higher priority processes. For this purpose, it is possible to provide for each process a certain period of time within which this process has to be executed. After this period of time has expired, either the priority identifier can be increased or the actual process can be carried out immediately.

Likewise, a system for warning about a break in and/or theft can have a high dynamic priority identifier in the state of rest. However, while in the operating state or traveling state of the vehicle, the system for warning about a break in and/or theft has a low priority identifier, or even none at all. The absence of a priority identifier can then mean that the process is not carried out at all in the traveling state.

By making available a waiting memory, it is possible for all the processes to be set there and sorted according to their priority identifier. The process with the highest priority identifier is then executed by the data processing unit or the hardware module, which makes available the next data processing resource. If, for example, a plurality of hardware modules are provided in parallel, the processes are assigned to them in succession according to their priority. In the case of a reconfigurable memory system, for example a FPGA, certain parts of the FPGA can be reconfigured into logic circuits by downloading a hardware configuration so that the control process can be carried out automatically using hardware. For this reason, in the method according to the invention, each process is also assigned a specific hardware configuration in order to be able to reconfigure the hardware module, if appropriate.

According to the invention, a control device for controlling components in a vehicle with an interface to an external data bus is described, the control device having at least one hardware module and one memory for making available the data necessary for the data processing. In this embodiment, there are a plurality of programmable hardware modules which can carry out further control processes in parallel with one another and communicate directly via the interface to the data bus and with sensors. The control device has a distribution unit which assigns a specific hardware module to each process. After the last control process has been executed, the hardware module is firstly reconfigured with the hardware configuration, and is thus prepared for the new control process. The control process which has the highest priority in the waiting memory is subsequently carried out on the reconfigured hardware module. After this control process has run, the FPGA is reconfigured again by using a hardware configuration, so that a new process with the next highest prioritization identifier can be loaded onto the hardware module for execution.

According to the invention, the control device has a plurality of hardware modules to which the execution of processes can be assigned, in parallel with one another, by the distribution unit. The distribution unit makes available here all the requests for the control process which has the highest priority in the waiting memory, so that the execution can be started immediately after the preceding process has been concluded. For this purpose, it is under certain circumstances necessary to make available the hardware configuration in order to reconfigure the respective hardware module for the process to be executed. For example, it is possible for just a portion of the hardware module to be affected, so that another process continues to run on the remaining chip area of the hardware module. The control device according to the invention has, in addition to the distribution unit, a system for assigning the priority identifier to the respective control process. It is possible to provide an internal bus which makes available the control process in an electronic form, i.e. makes available its data or information and the hardware configuration to the respective hardware module. A plurality of hardware modules, for example two to six, are then arranged on the internal data bus. The distribution unit has an interface to an external data bus to which the respective control device is connected. As a result, requests for processes which are signaled to the control device via the external data bus are prioritized and correspondingly processed immediately. Decompression units and flash memories may also be present in the control device. In the flash memory it is possible to make available both a hardware configuration for reconfiguring the modules and software modules, which can be carried out on the hardware module which is configured as a data processing unit. In addition, it is possible also to make available information for prioritizing the individual processes on the flash memory. A further memory is provided for initializing and powering up the configurable memory module, for example the FPGA.

As already described, a reconfigurable memory unit such as a FPGA can be provided as the hardware module. It is also possible to provide a plurality of microcomputers or hardware circuits which are connected in parallel, and to which assignments are made on the basis of the prioritization process. In this way, a parallel data processing system is produced, to which functions are assigned by the distribution unit using the different processes, and which is activated in such a way that the functional capacity utilization is correspondingly uniform and as effective as possible.

With FPGA implementation or implementation by using a configurable hardware module, it is particularly advantageous that important data bus data can be processed in real time with response times less than one millisecond. During this time, on the one hand a high priority process is made available and the hardware module is, if appropriate, reconfigured in accordance with a hardware configuration so that the execution takes place in this time. The hardware module is then available for further processes. After the reconfiguration of the hardware module, the data bus messages in the waiting memory are, if appropriate, executed as quickly as possible.

In terms of contemporary data bus frequencies, the parallel-connected control device with the hardware modules according to the invention is operated below its maximum processing frequency, thus a high potential for expansion is possible. As a result of the parallel operation, it is also possible for processes which can only be processed separately using a serial control device with microcomputer, to be executed within one control device. Because of the flexible prioritization identifier, such processes can be executed immediately, while slow processes or processes with a relatively low prioritization identifier, such as a window lifter, seat adjustment signals or sunroof signals, can only be executed afterwards.

The hardware modules can preferably be reconfigured for other processes during the running time of the associated vehicle, i.e. during stationary times or traveling times after it has been delivered from the manufacturing works. As a result, a highly flexible system is produced which can be adapted dynamically to the control tasks using initialization data and process description data or prioritization information. As a result, the system is also suitable for the use of classic control devices whose microcomputer or individual hardware modules are no longer manufactured nowadays. As a result of the hardware configuration, the control device according to the invention can be adapted to the requirements of these conventional control devices, and can simulate their tasks. Thus, the control device according to the invention is also useful for providing spare parts in the vehicle of the preceding generation.

The control device according to the invention is highly suitable for processing the method according to the invention, in which the first hardware module executes a current process, while the same or the other hardware module executes the process after the reconfiguration, in order to control a further process. The data processing capacity of the respective hardware modules is again enabled for the next control process immediately after the preceding process has been concluded. The distribution unit subsequently assigns a free hardware module to the control process with the highest priority identifier in the waiting memory, and makes available the required hardware configuration and the necessary information for the process, configures the hardware module if appropriate, and transmits the information associated with the process to the hardware module via the internal data bus, so that this control process can be executed. As a result, the component to be controlled can be activated.

There are various possible ways of advantageously configuring and developing the teaching of the present invention. In this respect, reference is made to the drawings, and to the following description of an exemplary embodiment. An exemplary embodiment of the device according to the invention is illustrated in the drawings, which illustrate the embodiment in a schematic illustration,

Other objects, advantages and novel features of the present invention will become apparent from the following detailed description of the invention when considered in conjunction with the accompanying drawings.

### BRIEF DESCRIPTION OF THE DRAWINGS

FIG. 1 is an illustration of a control device according to an embodiment of the invention, with four configurable hardware modules, and

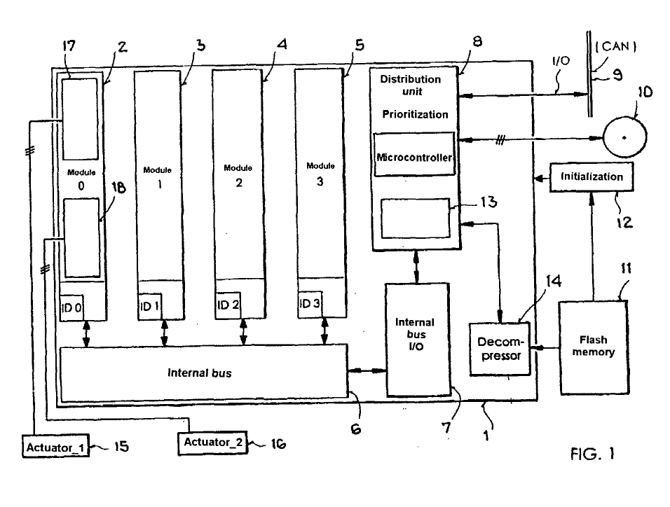

FIG. 2 is a flowchart of a method according to an embodiment of the invention, for executing processes by allocating priority identifiers.

### DETAILED DESCRIPTION OF THE DRAWINGS

The exemplary control device 1 for controlling components of a vehicle (not shown in the figure) has four internal configurable hardware modules 2, 3, 4 and 5, which are connected in an electrically conductive fashion to the distribution unit 8 via an internal data bus 6 and via an internal data bus I/O 7. The distribution unit 8 is connected to an external data bus 9, which is located outside the control device 1. In addition, the distribution unit 8 is connected to electric components, for example electric motors 10 and, if appropriate, sensors. A flash memory 11 is provided inside or outside in order to make available the necessary information for the control device 1. In the exemplary embodiment, it is possible to make available information such as a hardware configuration for the hardware modules 2 to 5, or prioritization information for the individual processes, or software modules for loading onto the hardware modules 2 to 5. An initialization memory 12 also makes available the data which is necessary to power up the control device and correspondingly initialize the hardware modules 2 to 5 and the other hardware components of the control device 1.

If a message which indicates, for example, the activation of a switch for starting a control process is transmitted, such as via the external data bus 9 which may be, for example, a CAN, Flexray, LIN or Firewire data bus, this message is transmitted to the distribution unit 8 via the input/output unit (I/O) of the external data bus 9. The distribution unit 8 prioritizes the incoming messages in accordance with the information previously loaded from the flash memory 11, and arranges these control processes in the waiting memory 13 in accordance with their assigned priority identifier. The information from the flash memory 11 is decompressed by the compression/decompression unit 14, so that the distribution unit 8 can read the information from the flash memory 11. The stored data is compressed in the flash memory 11 in order to use as little memory space as possible therein.

The exemplary hardware modules 2 to 5 can be configured independently of one another. The hardware modules 2 to 5 include data processing units which can be reconfigured in terms of hardware before a process is executed. The memories here are reconfigurable memories such as are known, for example, as FPGAs or by other designations. The individual memory cells of the hardware modules on the module chip are networked to one another redundantly so that the networking can be reconfigured. As a result, the memory cells can be wired differently to one another, so that the logic gates can be simulated or other complex data processing processes can be simulated. The logic gates can carry out the control process without additional software, and can make available actuation signals for sensors and actuators. In the case of a configurable memory unit or a data processing unit, it is then possible, if appropriate, to download software from the flash memory 11, which software can then run on one of the configurable hardware modules 2 to 5.

The hardware modules 2 to 5 are configured dynamically in accordance with the processes arranged in the waiting memory 13, and the distribution unit 8 assigns a process to a specific hardware module 2, 3, 4 or 5. In this embodiment, processes with a high prioritization identifier, which is equivalent to an urgent or important task, are passed on with preference to the next free hardware module 2 to 5. The information is then passed on via the internal bus I/O 7 and via the internal data bus 6 to the respective hardware module 2 to 5 and processed there. Various actuators 15, 16 are connected in an electrically conductive fashion to the modules 2 to 5 so that the hardware module 2 actuates the actuator 15 with, for example, a logic circuit embodied on a chip field 17. At the same time, a further data processing unit is formed on the same chip of the hardware module 2, on a chip face 18, in order to actuate the actuator 16, which for example may be a window controller or a sunroof.

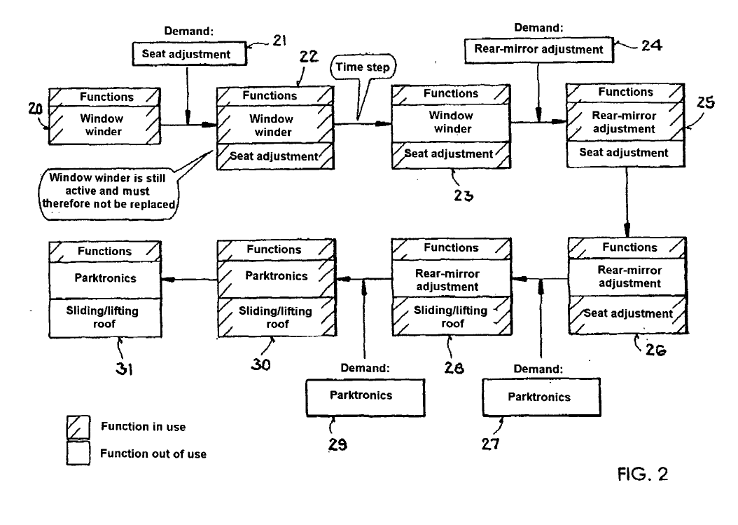

FIG. 2 illustrates the method for controlling a plurality of components 10, 15, 16 in a vehicle. The components 10, 15, 16 are connected here directly to the control device 1, and the control device 1 is in turn networked to further control devices via an external data bus 9. A first control program for controlling a window lifter 20 and a second control program 21 for adjusting seats is made available at the control device 1. The control process for the window lifter 20 and the control process 21 for adjusting seats are each chronologically limited, the starting time being generated, for example, by the activation of the adjustment knob for the window lifter or for adjusting a seat. The signal edge generates here a triggering event in the control device, in which case, for example, a message for the process is stored in the distribution unit 8 of the control device 1. Here, a higher priority identifier is assigned to the window lifter 20 than to the seat adjustment system 21.

If, for example, both processes are to be carried out in the hardware module 2 and are to be executed one after the other, the method according to the invention provides a process according to FIG. 2. Here, for example the request for the seat adjustment system 21 is activated by activating the seat adjustment switch while the process for the window lifter 20 is being executed. At 22, the process for adjusting the seat is set in the waiting memory 8 and provided with a priority identifier.

In the next time step, after the window lifter process 20 has been executed, the process is deleted from the waiting memory 13. At first, the seat adjustment is present with a maximum priority identifier in the waiting memory at 23. If the process 24 for adjusting the rear view mirror is then requested, and this has a higher priority identifier than the seat adjustment, the process for adjusting the rear view mirror is carried out first at 25. After the process for adjusting the rear view mirror has run, the process for seat adjustment is activated at 26 and executed, while the process for rear view mirror adjustment briefly becomes inactive, for example because of continued activation. The seat controller remains actuated in the meantime.

At 27, the process for the adjustment of the sliding and tilting sunroof is initiated by activating the sunroof, in which case, owing to the relatively high priority identifier of the sliding and tilting sunroof, its process is executed first at 28, while the rear view mirror adjustment remains inactive at 28 and is not carried out until after the sliding and tilting sunroof process has been concluded.

If, for example, the automatic parking system is requested at 30, the system also having a relatively high priority identifier, both processes must be executed simultaneously at 30. In this case, one process is allocated to the hardware module 2 and a further process is allocated to the hardware module 3, with the hardware module 3 being configured beforehand to the process for the parking system being executed. After the two processes have run, the two inactive functions are finally deleted from the waiting memory 13 at 31, so that further processes can be executed.

Each process is assigned a priority identifier in each case, and at the starting time of each process it is checked whether another running process is already being carried out. In this case, the first process is then input in a waiting memory, and after the running process has been concluded, the process stored in the waiting memory with the highest priority identifier is read out and assigned to the corresponding hardware module 2 to 5.

The priority identifier can be allocated dynamically to each process, i.e. the priority identifiers can change as a function of the operating states of the vehicle. If, for example, the vehicle is in a parking situation or is moving at a low velocity, the parking system or the sunroof or else the immobilizer is provided with a higher priority identifier than is the case if the vehicle is moving at a relatively high velocity. Owing to the dynamic allocation of the priority identifiers and the assignment of the process with the highest priority to the respectively free hardware modules 2 to 5, it is possible for serial or else parallel processing of different processes to occur in the vehicle in a particularly effective way.

The following list of reference numerals is provided to further facilitate understanding of the invention.
1 Control device
2-5 Hardware modules
6 Internal data bus
7 Internal bus I/O
8 Distribution unit
9 External data bus
10 Actuator
11 Flash memory
12 Initialization unit
13 Waiting memory
14 Compression/decompression unit
15, 16 Actuator
17 Chip area of the hardware module
18 Chip area of the hardware module
19 Free
20 Process for window lifter
21 Process for seat adjustment
22 Allocation of the priority identifier
23 Process for seat adjustment underway
24 Request for rear view mirror adjustment
25 Process for rear view mirror adjustment underway
26 Process for seat adjustment underway
27 Request for sliding and tilting sunroof
28 Sliding and tilting sunroof process underway
29 Request for parking system
30 Execution of parallel processes
31 Completion of processes and enabling of waiting memory

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A method for controlling the execution of control processes in a control device of a vehicle, the method comprising the acts of:
assigning chronologically via a distribution unit the control processes to a plurality of hardware modules of the control device for execution in parallel;
providing to the control device a first control program for a first component and a second control program for a second component, each control program carrying out a chronologically limited control process for controlling the respective component;
determining for each control process a start time and an end time, the start time being defined by a triggering event;
assigning to each of the control processes a priority identifier;
checking at the starting time of a first control process whether another running control process has already been executed;
if another running control process has already been executed, inputting the first control process into a waiting memory;
reading out of the waiting memory a next control process to be executed, in accordance with its priority identifier;
after the running control process has been concluded, either by regular conclusion or an abort, starting to control a corresponding component with a highest priority control process, wherein the priority identifier is allocated dynamically, and wherein different traveling or operator control situations of the vehicle result in allocation of different priority identifiers to respective processes;
executing the control processes for components which can be actuated in parallel in the control device; and
selecting from the waiting memory a control process with the highest priority and assigning it to one of the hardware modules which are available in parallel.

13. The method as claimed in claim 12, further comprising the acts of differentiating into at least two states during the allocation of the dynamic priority identifier, one state corresponding to an operating state of the vehicle and another state corresponding to a state of rest of the vehicle in which the means of transportation is not moving to provide transportation.

14. The method as claimed in claim 13, further comprising the act of assigning a different dynamic priority to a control process in the state of rest of the vehicle than in the operating state of the vehicle.

15. The method as claimed in claim 13, further comprising the act of assigning a high dynamic priority identifier in the state of rest to a system for warning about break-ins and/or theft.

16. The method as claimed in claim 13, further comprising the act of assigning a relatively low dynamic priority identifier in the state of rest and a relatively high priority identifier in the operating state to processes for controlling passenger compartment components.

17. The method as claimed in claim 12, further comprising the acts of:
selecting the process with the highest priority identifier when a preceding process in the waiting memory is concluded; and
making the selected process available for execution in the hardware module of the control device.

18. A control device for controlling components in a vehicle with an interface to an external data bus, comprising:
programmable hardware modules to carry out control processes in parallel with one another, and to communicate directly via the interface with at least one of the external data bus and sensors/actuators;
a memory for making available data necessary for data processing;
a distribution unit of the control device for assigning a first control process to a first of the programmable hardware modules by means of messages from the data bus, and for assigning a further control process to one of the first programmable hardware module and a second programmable hardware module; wherein,
the first hardware module is configured to carry out the first control process;
the second hardware module is configured to carry out a further control process, so that the first hardware module executes a process while one of the first and second hardware modules executes said process after a reconfiguration in order to control a further process; and
data processing capacity of the hardware modules is enabled again for a next control process immediately after a respective process has been concluded.

19. The control device as claimed in claim 18, wherein the hardware module comprises a programmable control unit (FPGA) whose memory cells are configurable using programmable connecting lines.

20. The control device as claimed in claim 18, wherein the hardware module is reconfigurable during running time of the assigned means of transportation for other processes.

21. The method as claimed in claim 12, further comprising the acts of controlling the control processes on a device with hardware modules which carry out different control processes and in parallel.

22. A method for controlling devices in a vehicle, comprising the acts of:
receiving in a control device a triggering signal for control of a first component;
designating in the control unit a priority identifier of a first control process of the first component;
assigning via a distribution unit of the control device a hardware module to execute the first process;
comparing the priority identifier of the first control process to priority identifiers of additional control processes;
when the first control process has a highest priority identifier, configuring the hardware module for execution of the first control process; and
executing the first control process on the configured hardware module to control the first component.

23. The method according to claim 22, further comprising the acts of storing the first control process in a waiting memory when one of the additional control processes has a higher priority identifier.

24. The method according to claim 23, further comprising the acts of selecting a process with the highest priority identifier from the waiting memory.

25. The method according to claim 22, further comprising the act of dynamically designating the priority identifier associated with the first component as a function of a state of the means of transportation.

26. The method according to claim 25, wherein the act of dynamically designating the priority identifier differentiates between an operating state and a state of rest of the means of transportation.

27. The method according to claim 24, further comprising the act of configuring the hardware module for execution of the process with the highest priority identifier.

28. The method according to claim 22, further comprising the act of assigning a portion of the hardware module to execute the first process.

29. The method according to claim 22, further comprising the act of assigning multiple hardware modules to execute the first process simultaneously and in parallel.

30. The method according to claim 22, further comprising the act of determining higher priority identifiers for safety-related control processes.

31. The method according to claim 22, further comprising the act of chronologically limiting the first control process from the triggering signal.
